(19) United States
(12) Patent Application Publication
(10) Pub. No.: US 2016/0185207 A1
(43) Pub. Date: Jun. 30, 2016

(54) ELECTRIC-DRIVE ALL-TERRAIN UTILITY VEHICLE

(71) Applicants: Joseph Gerschutz, Wall Township, NJ (US); Todd J. Bullivant, Cream Ridge, NJ (US); Joshua Denholtz, New Brunswick, NJ (US); Matthew Drozdowicz, Beachwood, NJ (US)

(72) Inventors: Joseph Gerschutz, Wall Township, NJ (US); Todd J. Bullivant, Cream Ridge, NJ (US); Joshua Denholtz, New Brunswick, NJ (US); Matthew Drozdowicz, Beachwood, NJ (US)

(73) Assignee: MILSPRAY, LLC, Lakewood, NJ (US)

(21) Appl. No.: 14/872,108

(22) Filed: Sep. 30, 2015

Related U.S. Application Data
(60) Provisional application No. 62/057,299, filed on Sep. 30, 2014.

(51) Int. Cl. B60K 6/52; B60K 6/365; B60R 21/13; B60K 17/344; B60K 17/348; B60K 6/24; B60K 17/16

(52) U.S. Cl. CPC B60K 6/52; B60K 6/24; B60K 6/365; B60K 17/16; B60K 17/344; B60K 17/348; B60R 21/13; Y10S 903/916; Y10S 903/905; Y10S 903/91; B60R 2021/0018

(57) ABSTRACT

The invention is an all-terrain utility vehicle comprising: a support chassis frame; four wheels removably attached to respective adjustable suspension components that are removably attached to the support chassis frame; a transfer case, an electric motor, and an engine mounted on the support chassis frame; removable personnel seats; and a battery mounted on the support chassis frame.

### CROSS REFERENCE TO RELATED APPLICATION

The present application is related to Provisional Patent application entitled “Electric Drive All-Terrain Utility Vehicle,” filed 30 Sep. 2014 and assigned filing No. 62/057,299, incorporated herein by reference in its entirety.

### FIELD OF THE INVENTION

This invention relates to a utility vehicle and, in particular to a military electric drive all terrain hybrid utility vehicle.

### BACKGROUND OF THE INVENTION

Various configurations of off-road, passenger vehicles have been known in the art for some years. In particular, emergency responder and military vehicles have been designed to operate in hostile environments. Such vehicles benefit from the use of a minimal number of components so as to keep vehicle weight to a minimum.

For particularly challenging terrain, such as sand, mud, and inclined surfaces, many conventional all-terrain vehicles tend to be slow and large, and ineffective. Moreover, these vehicles have limited application to military use, as there is typically no armor plating, or other protection, provided for protection against ballistic projectiles.

What is needed is a lightweight all-terrain vehicle, capable of conveying up to four personnel, that can be transported by air for deployment to a hostile environment, and which includes ballistic protection for the personnel.

### BRIEF SUMMARY OF THE INVENTION

In one aspect of the present invention, an all-terrain utility vehicle comprises: a support chassis frame; four wheels removably attached to respective adjustable suspension components that are removably attached to the support chassis frame; a transfer case, an electric motor, and an engine mounted on the support chassis frame; removable personnel seats; and a battery mounted on the support chassis frame.

In another aspect of the present invention, an all-terrain utility vehicle comprises: a support chassis frame having a substantially rectangular perimeter frame with two substantially parallel longitudinal supports structurally attached to the support chassis frame; four wheels removably attached to respective adjustable front suspension components and removably attached to the support chassis frame; a transfer case mounted between the longitudinal supports and coupled to an electric motor mounted between the longitudinal supports, the transfer case further coupled to an engine mounted between the longitudinal supports; removable personnel seats mounted on the support chassis frame; and at least one battery mounted on the support chassis frame and electrically connected to the electric motor.

The additional features and advantage of the disclosed invention is set forth in the detailed description which follows, and will be apparent to those skilled in the art from the description or recognized by practicing the invention as described, together with the claims and appended drawings.

### BRIEF DESCRIPTION OF THE DRAWINGS

FIG. 1 is an isometric illustration of a military electric-drive all-terrain utility vehicle with a protection cage and seats, in accordance with the present invention;

FIG. 2 is a top view of the utility vehicle of FIG. 1 showing the protection cage and layout of some of the vehicle components; and

FIG. 3 is a diagrammatical top view of the utility vehicle of FIG. 1 without the protection cage and the seats.

### DETAILED DESCRIPTION OF THE INVENTION

The invention satisfies the need for a utility vehicle that provides high mobility, high functionality, high performance, stealthy operation, and protection. The vehicle is designed with off-road capabilities enabling it to navigate complex terrain. An electrical energy storage and drive system enables functionality such off-board of power, high efficiency, and flexible recharging options—including recharging “on the fly” from an on-board generator.

High performance is designed into the system, including a powerful high torque electric motor. The electrical drivetrain produces little to no noise as compared to drive trains of comparable internal combustion vehicles. As such, the disclosed utility vehicle is able to operate very discreetly when required by the operational environment. Ballistic protection to improve personnel and vehicle survivability is built-in for applications such as for military use.

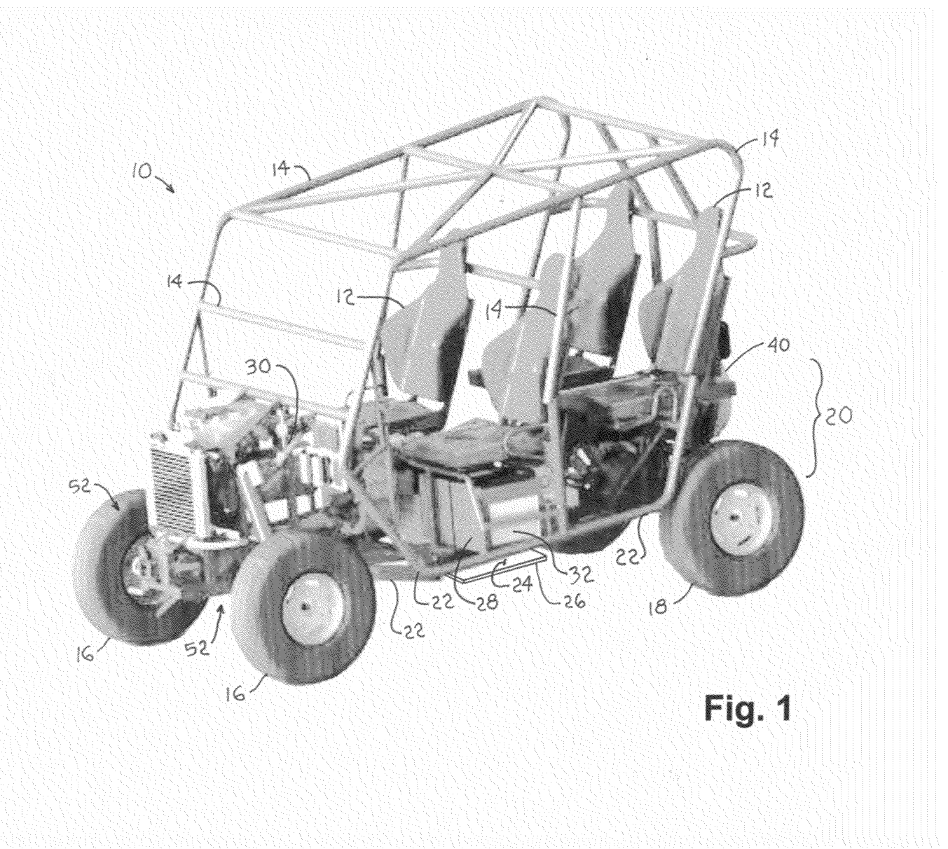

There is shown in FIG. 1 an electric-drive all-terrain (EDAT) utility vehicle 10, in accordance with the present invention. In an exemplary embodiment, the EDAT utility vehicle 10 includes one to four personnel seats 12, each with a 4-point seatbelt, each personnel seat 12 individually mounted on a support chassis frame 22 in a support chassis assembly 20. The EDAT utility vehicle 10 can be used to transport a payload of at least 1000 pounds, including personnel. A removable roll-over protection (ROP) cage 14 enclosing all seated personnel may be structurally attached to the support chassis frame 22.

In the example shown, two front wheels 16 and two rear wheels 18 form part of the support chassis assembly 20. In an exemplary embodiment, the wheels 16, 18 comprise run-flat, bead-lock tires on rims that, in combination with respective adjustable suspension components 52, can provide an equilibrium ground clearance of approximately ten inches. There may be dual piston disc front brakes at the front wheels 16; and sealed multi disc rear brakes at the rear wheels 18.

Motive power is selectively provided by an electric motor 30, mounted at the front of the EDAT utility vehicle 10. The EDAT utility vehicle 10 also includes an internal combustion engine 40, mounted at the rear of the EDAT utility vehicle 10. Both the electric motor 30 and the internal combustion engine 40 are structurally attached to the support chassis frame 22 with a drive train separately coupled to the front wheels 16 and the rear wheels 18. Electrical power may be provided to the electric motor 30 by one or more batteries 32 mounted on the support chassis frame 22.

In an alternative embodiment, one or more individual hub motors (not shown) may be used in place of the electric motor 30. The electric motor 30 is the primary device that provides torque to drive the wheels 16, 18. The engine 40, which functions as part of an electrical generator, is primarily used to supply electric power for immediate use by the electric motor 30, or is stored energy in the batteries 32 for later use by the electric motor 30.

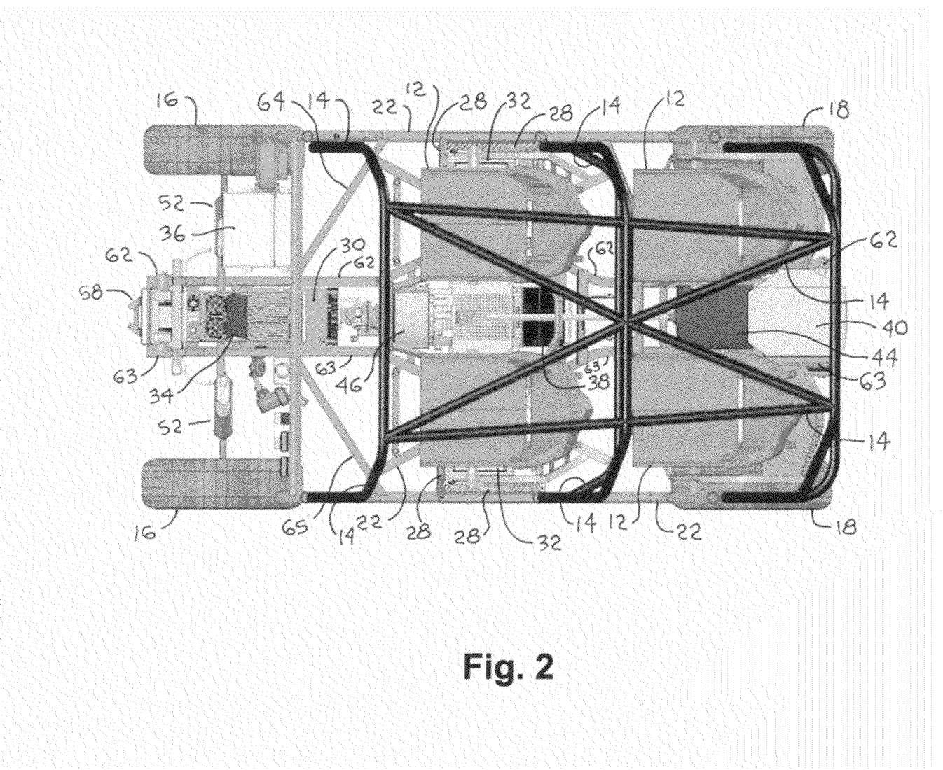

A blast mitigating skid plate 24 may be attached to the underside of the support chassis frame 22 to provide protection to personnel and sensitive equipment. The skid plate 24 may be a substantially rectangular metal or composite plate, having a first dimension approximately equal to the width of the support chassis frame 22, and a second dimension sufficient to protect the entire seating area of the personnel in the EDAT utility vehicle 10. The skid plate 24 is mechanically secured to the underside of the support chassis frame 22 by any suitable method known in the art. An underbody blast coating 26 may be applied to the surfaces of the blast mitigating skid plate 24 to reduce spalling of the blast mitigating skid plate 24. Composite material armor plates 28 may be provided on one or more of the sides, the front, and the rear of the personnel seats 12 and the batteries 32, as shown in FIG. 2. The composite material armor plates 28 function to provide up to 5.56NATO ballistic protection to the personnel and to critical EDAT utility vehicle 10 components (not shown).

It can be seen in FIG. 2 that the support chassis frame 22 is configured with a substantially rectangular perimeter frame fabricated of structural members or beams, and includes two substantially parallel longitudinal supports 62 and 63 (i.e., structural members or beams) running the length of the EDAT utility vehicle 10. As shown in the illustration, the longitudinal supports 62, 63 extend between a fore end of the EDAT utility vehicle 10 and an aft end of the EDAT utility vehicle 10.

An electric motor 30 is mounted between the longitudinal supports 62 and 63 forward of the personnel seats 12. The engine 40 is mounted between the longitudinal supports 62 and 63, generally aft of the personnel seats 12. Motive power is provided to the wheels 16, 18 via a transfer case 46, also located between the longitudinal supports 62 and 63. The support chassis frame 22 may also include a first transverse strut 64 between the outer perimeter of the support chassis frame 22 and the longitudinal support 62, and a second transverse strut 65 between the outer perimeter of the support chassis frame 22 and the longitudinal support 63, where the transverse struts 64, 65 are similarly fabricated from structural members or beams.

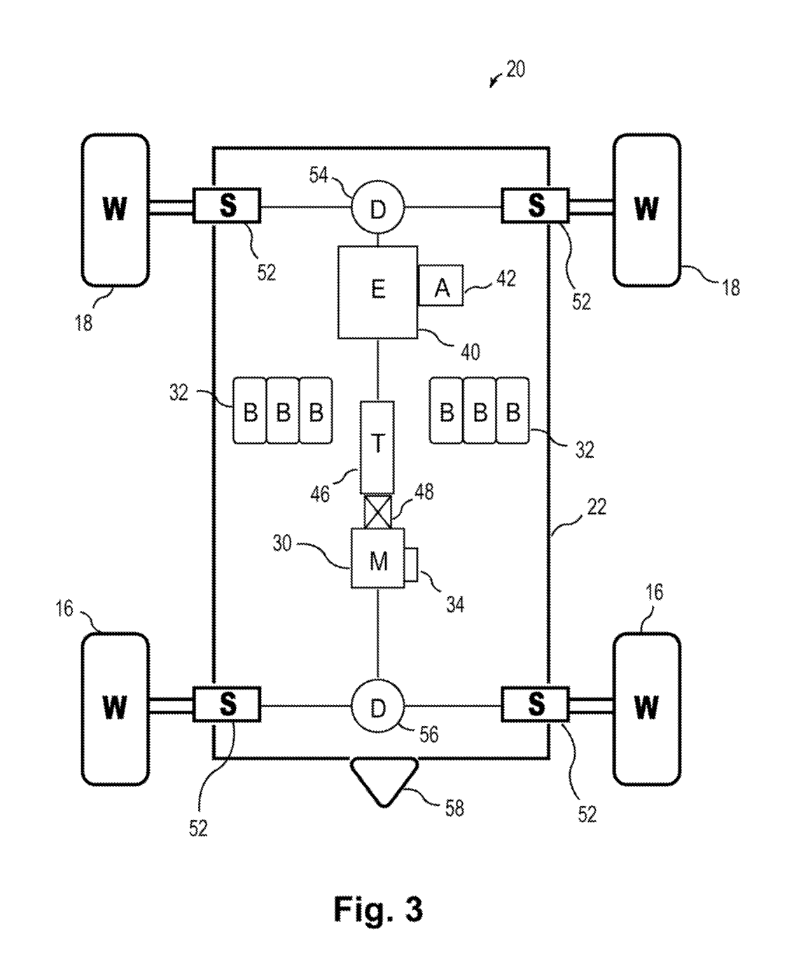

A motor controller 34 may be provided for operation of the electric motor 30, and a reversing contacts module 36 may be provided to control direction and operation of the wheels 16, 18 when powered by either the electric motor 30 or the engine 40 with the electric motor 30. The power train in the EDAT utility vehicle 10 thus includes the engine 40 with the electric motor 30, the transfer case 46, fore and aft differentials 54, 56 (shown in FIG. 3), and adjustable suspension components 52 terminating at the wheels 16, 18.

Switching between rear-wheel drive and all-wheel drive is preferably controlled in the differentials 54, 56. Motive power from the electric motor 30 is constantly delivered to the front wheels 16, whether the EDAT utility vehicle 10 is in two-wheel drive mode or in four-wheel drive mode. When switching to two-wheel drive, the fore differential 56 disengages motive power from the front wheels 16. In an alternative embodiment, the selective switching of motive power to the front wheels 16 may be controlled by the transfer case 46.

An alternator 42 is coupled to the engine 40 to produce, in combination with the engine 40, a generator 44. Preferably, the alternator 42 is selected for having suitable performance characteristics such that the generator 44 can output up to about six kW at 240 VAC. In an automatic mode of operation, the alternator 42 automatically operates when the charge level of the batteries 32 fall below a predetermined level. The alternator 42 automatically shuts off after the batteries 32 have been fully charged. In a manual mode of operation, the alternator 42 can be turned on, and remains on, charging the batteries 32 as needed. In a manual off/lock out mode of operation, the alternator 42 is off, and will not automatically start, even if the batteries 32 reach a low state of charge.

The configuration of the EDAT utility vehicle 10 further provides for a “battle short” mode of operation. In the battle short mode, a self-protect feature is bypassed so as to enable the operator to maintain vehicle performance for as long as possible. This mode allows the operator to use the EDAT utility vehicle 10 at maximum performance, even if there is a risk of damage to vehicle components under the maximum performance condition. One of the self-protect features designed into the EDAT utility vehicle 10 includes the automatic throttling of vehicle performance when the maximum allowable temperature of the electric motor 30 has been exceeded. Another such self-protect feature prevents discharge of the batteries 32 when voltage is below a minimum allowable value.

Referring now to FIG. 3, there is shown a simplified functional diagrammatical top view of major components provided in the EDAT utility vehicle 10. For clarity of illustration, the personnel seats 12, the roll-over protection cage 14, the longitudinal supports 62 and 63, mechanical interconnections and mounting components, and electrical wiring are not shown.

As described above, the support chassis frame 22 provides a mounting structure for the engine 40. In an exemplary embodiment, the engine 40 may comprise an air-cooled, diesel-fueled, internal combustion engine. A fuel tank (not shown) may also be mounted to the support chassis frame 22 with a fuel line (not shown) routed to the engine 40.

As described above, the support chassis frame 22 provides a mounting structure for the electric motor 30 and also for one or more batteries 32 used to power the electric motor 30. It can be appreciated that the EDAT utility vehicle 10 can be driven with full performance using only the power from the charged batteries 32. In an exemplary embodiment, the batteries 32 may comprise rechargeable Lithium-Ion battery units. Under battery power alone, the EDAT utility vehicle 10 may have a range of up to fifty miles using advanced battery technology to provide up to a combined capacity of up to 160 kW of electrical power, with a wider temperature operating window, compared to conventional battery technology. In an alternative embodiment, the EDAT utility vehicle 10 may include a solar source of energy, or a renewable source of energy, such that the EDAT utility vehicle 10 is not completely dependent upon traditional fuel sources, such as diesel fuel.

When required, the batteries 32 may be recharged from the alternator 42, via the battery management system 38, when the engine 40 is operating. An electrically-powered recovery winch 58 may be provided at the front end of the support chassis frame 22. A steering mechanism (not shown for clarity of illustration) may include an electrical power assist. In an exemplary embodiment, water-sensitive electrical and electronic components may be mounted a minimum vertical distance of about twenty inches from the ground plane. This configuration serves to protect the water-sensitive components when the EDAT utility vehicle 10 is being used to ford a water hazard.

The electric motor 30 is mechanically coupled to a transfer case 46 to form a power train for driving the EDAT utility vehicle 10. The transfer case 46 is mechanically coupled to an aft differential 54 for powering the rear wheels 18, and is also mechanically coupled to a fore differential 56 for powering the front wheels 16. A forward/reverse module 48 is mechanically coupled between the electric motor 30 and the transfer case 46. The forward/reverse module 48 is electrically switchable so as to enable an operator to selectively drive the EDAT utility vehicle 10 in a forward direction or in a reverse direction.

The drivetrain in the EDAT utility vehicle 10 thus comprises the electric motor 30, the transfer case 46, the aft differential 54, the fore differential 56, the front wheels 16, and the rear wheels 18. As can be appreciated by one skilled in the art, the disclosed drivetrain provides for silent driving and has a low thermal signature. In particular, the drivetrain offers flexible capabilities selectable between a rear-wheel drive configuration and all-wheel drive (i.e., 2WD/4WD) with the additional feature of having HI/LO gearing for extreme off-road conditions. The engine 40 is similarly selectively coupled to the drivetrain so as to provide an extended driving range of up to two hundred fifty miles, without using battery power and the electric motor 30.

The front wheels 16 and the rear wheels 18 are each mechanically coupled to the support chassis frame 22 via respective front adjustable suspension components 52 and rear adjustable suspension components 52, as is known in the art. The front and rear adjustable suspension components 52 may also be removable, and interchanged with different suspension components (not shown) to provide different suspension characteristics for different terrain conditions. Preferably, the front and rear suspension components 52 are tuned to enable optimal performance of the EDAT utility vehicle 10 under both low-speed off-road operation and high-speed maneuvering on paved surfaces.

The EDAT utility vehicle 10 may further include swing arm universal weapons mounts (not shown) for personnel, and optional overhead weapons mounts (not shown). Infrared lights (not shown) may also be mounted on the support chassis frame 22 when required for blackout capability.

In an exemplary embodiment, the above design features may be embodied in an EDAT utility vehicle having: (i) an elevation operating range of from −300 ft. to about 10,000 feet; (ii) operational capability under an ambient temperature range of from about −25° F. to about +120° F.; (iii) a top speed of about sixty mph; (iv) an all-electric range of about fifty miles; (v) an all-engine range extension of about two hundred fifty miles with a fuel capacity of about 7.5 gallons; (vi) a turning radius of about 16.7 feet; (vii) operational capability on longitudinal slopes and side slopes up to about forty five degrees; (viii) twenty six inch tires; (ix) a wheelbase of approximately 86.1 inches; (x) an overall length of about 125 inches; (xi) an overall width of about sixty inches; (xii) an overall height of about 76.3 inches; and (xiii) a curb weight of about 3000 pounds. As can be appreciated by one skilled in the relevant art, the external dimensions (x), (xi), and (xii) allow for the EDAT utility vehicle 10 to be loaded into a V-22 special operations aircraft for transport by air.

It is to be understood that the description herein is only exemplary of the invention, and is intended to provide an overview for the understanding of the nature and character of the disclosed military electric-drive all-terrain utility vehicle. The accompanying drawings are included to provide a further understanding of various features and embodiments of the method and devices of the invention which, together with their description serve to explain the principles and operation of the invention.

What is claimed is:

1. An all-terrain utility vehicle comprising:
a support chassis frame;
two front wheels, each front wheel removably attached to respective adjustable suspension components, said adjustable suspension components removably attached to said support chassis frame, said two front wheels coupled to a fore differential;
two rear wheels, each rear wheel removably attached to respective adjustable suspension components, said adjustable suspension components removably attached to said support chassis frame, said two rear wheels coupled to an aft differential;
a transfer case mounted on said support chassis frame, said transfer case coupled to said fore differential and to said aft differential;
an electric motor mounted on said support chassis frame, said electric motor coupled to said transfer case;
an engine mounted on said support chassis frame, said engine coupled to said transfer case;
at least three removable personnel seats mounted on said support chassis frame; and
at least one battery mounted on said support chassis frame, said at least one battery electrically connected to said electric motor.

2. The all-terrain utility vehicle of claim 1 further comprising a removable roll-over protection cage removably attached to said support chassis frame.

3. The all-terrain utility vehicle of claim 1 wherein said engine comprises a diesel engine.

4. The all-terrain utility vehicle of claim 1 further comprising a skid plate mounted to an underside of said support chassis frame, said skid plate fabricated from one of a metal plate and a composite plate.

5. The all-terrain utility vehicle of claim 1 wherein said support chassis frame comprises a substantially rectangular perimeter frame having two substantially parallel longitudinal supports structurally attached to said support chassis frame, said two longitudinal supports extending between a fore end of said all-terrain utility vehicle and an aft end of said all-terrain utility vehicle.

6. The all-terrain utility vehicle of claim 5 further comprising two transverse struts extending between said rectangular perimeter frame and said two longitudinal supports.

7. The all-terrain utility vehicle of claim 6 wherein at least one of said transfer case, said electric motor, and said engine is disposed between said two longitudinal supports.

8. The all-terrain utility vehicle of claim 5 further comprising an alternator mechanically coupled to said engine, said alternator further electrically connected to said electrical motor.

9. The all-terrain utility vehicle of claim 1 wherein at least one said adjustable suspension component is switchable between providing motive force to a coupled wheel and disengaging said motive force from said coupled wheel.

10. The all-terrain utility vehicle of claim 1 wherein said transfer case is switchable between providing motive force to said fore differential and disengaging said motive force from said fore differential.

11. The all-terrain utility vehicle of claim 1 further comprising a forward/reverse module mechanically coupled between said electric motor and said transfer case, said forward/reverse module being electrically switchable so as to enable an operator to selectively drive said all-terrain utility vehicle in a forward direction or in a reverse direction.

12. An all-terrain utility vehicle comprising:
a support chassis frame, said support chassis frame having a substantially rectangular perimeter frame with two substantially parallel longitudinal supports structurally attached to said support chassis frame, said two longitudinal supports extending between a fore end of said all-terrain utility vehicle and an aft end of said all-terrain utility vehicle;
two front wheels, each front wheel removably attached to respective adjustable front suspension components removably attached to said support chassis frame, said two front wheels having a fore differential disposed between said adjustable front suspension components;
two rear wheels, each rear wheel removably attached to respective adjustable rear suspension components removably attached to said support chassis frame, said two rear wheels having an aft differential disposed between said adjustable aft suspension components;
a transfer case mounted between said longitudinal supports, said transfer case coupled to an electric motor mounted between said longitudinal supports, said transfer case further coupled to an engine mounted between said longitudinal supports;
at least three removable personnel seats mounted on said support chassis frame; and
at least one battery mounted on said support chassis frame, said at least one battery electrically connected to said electric motor.

13. The all-terrain utility vehicle of claim 12 wherein said two front wheels are positioned relative to said two rear wheels so as to form a wheelbase of approximately eighty six inches.

14. The all-terrain utility vehicle of claim 12 having outside dimensions of approximately 125 inches in overall length, approximately sixty inches in overall width; and approximately seventy six inches in overall height.

15. The all-terrain utility vehicle of claim 12 further comprising at least one armor plate disposed against said at least one battery.

16. The all-terrain utility vehicle of claim 12 wherein said electric motor is mounted forward of said at least three personnel seats, and said engine is mounted aft of said at least three personnel seats.
